(19) United States
(12) Patent Application Publication
(10) Pub. No.: US 2009/0182586 A1
(43) Pub. Date: Jul. 16, 2009

(54) POINT-OF-SALE, VALUE-ADDED PAYMENT PROCESSING SYSTEM AND METHOD THEREOF

(76) Inventor: JOSEPH P. COHANE, Norcross, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/352,366

(22) Filed: Jan. 12, 2009

Related U.S. Application Data
(60) Provisional application No. 61/010,655, filed on Jan. 10, 2008.

(51) Int. Cl. G06Q 20/00; G06Q 10/00; G06Q 40/00; G06Q 50/00; G06Q 30/00

(52) U.S. Cl. 705/4; 705/30; 705/21; 705/19; 705/40; 705/14

(57) ABSTRACT

A point-of-sale, value-added payment processing system and method thereof comprising, in general, a central server system connected to a data processing and storage device that utilizes a computer program adapted to host, accrue, calculate, disburse and report monthly donations earned by a participating merchant, based upon credit card processing transaction volume, thus offering a simple and easy to use turnkey solution that can integrate a complete donation funding option at the point of sale device, wherein merchants receive a point-of-sale benefit, related to payment processing transactions, in the form of a donation based upon transaction totals, wherein software tracks and reports the transaction-generated donations maintained in escrow, and wherein such informational data is readily accessible to participating merchants in order that each merchant may selectively access escrow donations for contribution to a customer's immediate need.

### CROSS-REFERENCE AND PRIORITY CLAIM TO RELATED APPLICATION

To the fullest extent permitted by law, the present U.S. Non-Provisional patent application claims priority to and the benefit of U.S. Provisional patent application entitled “Point-of-Sale, Value-Added Payment Processing System and Method Thereof,” filed on Jan. 10, 2008, on behalf of inventor Joseph P. Cohane, and having assigned Ser. No. 61/010,655.

### COPYRIGHT NOTICE

A portion of the disclosure of this patent document may contain material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to credit processing services, and more specifically to a point-of-sale, value-added payment processing system and method thereof. The present invention is particularly suitable for, although not strictly limited to, veterinary service providers, wherein such participants may contribute a portion of their monthly payment processing fees to their customers, such as those who are financially challenged, to pay for pet care services, wherein such contributions may be donated by the payment processing service provider, and wherein the accrued, donated funds are available for essentially immediate grant, at the discretion of the veterinarian.

### BACKGROUND OF THE INVENTION

Consumers routinely pay for goods and services via credit card, frequently electing to do so because of convenience, ease of recordkeeping, and decreased necessity for carrying cash. Given the plethora of available credit card management companies and banks, cards are heavily marketed to consumers for targeted selection. For example, many cards market based upon interest rates, attempting to appeal to those consumers who may carry a balance. Others offer rewards, such as redeemable points or cash back incentives, in order to appeal to those consumers who charge regularly and who may or may not maintain a balance.

Given the foregoing dynamic, most merchants and service providers find that acceptance of credit cards for payment is essential to business. As with the plethora of credit card management companies and banks, there similarly exists a large selection of credit card payment processing providers. These providers compete for the opportunity to process the credit transactions, typically seeking compensation based upon percentage of each transaction. In addition to such fees, however, there exists another valuable commodity for the point-of-sale service provider, information. Data in merchant portfolios is acquired and grown via software applications, wherein this data is mined as an additional revenue stream to the payment processing service provider.

The pricing of such payment processing services to the merchant is a point of competition, wherein service selection is frequently based solely thereon. Some services, however, disadvantageously obscure the true pricing structure via hidden charges and delayed reporting and/or crediting of transactions. Reports to the merchant are delayed, frequently for extended periods. The merchants, unfortunately, must generally opt for acceptance of such terms because credit card transactions are so critical to ongoing business.

Payment processing services typically pass through a commercial bank to the merchant, wherein known verticals exist in the form of financial incentives, but these do not benefit the merchant, but instead are returned to the commercial bank that is party to the transactions. Rewards for transactional use are typically reserved for the consumer, and rewards for processing are typically reserved for the party financial institution. Thus, each participating party to the transaction receives a financial incentive at the expense of the merchant.

Therefore, it is readily apparent that there is a need for a point-of-sale, value-added payment processing system and method thereof, wherein clarity of pricing and web-based transaction reporting are provided, and wherein a portion of the payment processing fee is held in escrow for essentially immediate funding for a target charitable cause, at the discretion of the merchant, related to the goods and services thereof.

### BRIEF SUMMARY OF THE INVENTION

Briefly described, in a preferred embodiment, the present invention overcomes the above-mentioned disadvantages and meets the recognized need for such a system and method by providing a payment processing service, wherein merchants receive a point-of-sale benefit in the form of a donation based upon transaction totals, wherein software tracks and reports the transaction-generated donations maintained in escrow, and wherein such informational data is readily accessible to participating merchants in order that each merchant may selectively access escrow donations for contribution to a customer's immediate need.

According to its major aspects and broadly stated, the present invention in its preferred form is a point-of-sale, value-added payment processing system and method thereof comprising, in general, a central server system connected to a data processing and storage device that utilizes a computer program adapted to host, accrue, calculate, disburse and report monthly donations earned by a participating merchant, based upon credit card processing transaction volume, thus offering a simple and easy to use turnkey solution that can integrate a complete donation funding option at the point of sale device.

More specifically, the preferred system and method of providing the point-of-sale service of the present invention is embodied in software, one commodity of which is data, wherein merchant portfolios may be grown in acquisition mode, thus providing information gathering services. The payment processing system and method of the present invention preferably further comprises exceptional payment processing services coupled with web-based reporting and data management.

The payment processing service programs are fairly and transparently priced, wherein revenues earned by the service provider through the processing fees are derived from the credit card transaction volume; and this volume is based on the capture and settlement of electronic transactions, thereby ensuring clarity to the merchant, wherein participating businesses that accept credit cards are provided with value-added services, as well as products. For example, a veterinary service provider may elect for contributions made by the payment processing service provider based upon monthly payment processing fees to be available for selective contribution to consumers with emergency pet care needs and who are unable to meet those needs financially. In such a scenario, not only does the veterinarian receive the personal reward of bestowing the grant upon the needy party, other customers are encouraged to present full payment via credit card at the time services are rendered in order to indirectly contribute to future grants.

A recognizably tangible benefit of the system and method of the present invention is immediacy of the grant, wherein normal rules stratus generally require weeks for receipt of funding from charitable organizations for a charitable cause. In emergency situations, such as the need for urgent pet care, a delay of any magnitude may result in serious illness, exacerbation of issues, and even death of the animal. That is, the funds that are in the “escrow” for grant purposes allow for essentially immediate funding, wherein available donation funds and transactional reports are provided, electronically or otherwise, to allow for immediate answer regarding both availability and transfer of funding.

Accordingly, a feature and advantage of the present invention is the ability of such a system and method to encourage merchant use thereof via value-added at the point of sale transaction.

Another feature and advantage of the present invention is the ability of such a system and method to be developed as a stand-alone software application that integrates with point-of-sale credit card terminals and/or as a full end-to-end solution as a merchant processing donation product.

Another feature and advantage of the present invention is the ability of such a system and method to enable a merchant and/or service provider, such as a veterinarian, to contribute a portion of the service provider's monthly credit and debit processing fees to the merchant and/or service provider's own customer's who are in need of financial assistance in order to utilize and/or receive goods and services from the merchant and/or service provider, such as emergency pet care needs from a veterinarian.

Still another feature and advantage of the present invention is the ability of such a system and method to maintain a plurality of financial electronic transactions, such as those related to hosting, accruing, calculating, disbursing, and reporting of monthly donations earned by the merchant according to credit card processing transaction volume.

Yet another feature and advantage of the present invention is the ability of such a system and method to integrate with known Veterinary Management Care Solutions (VCMS) as a point-of-sale addition via certification of VMCS vendors, and/or to calculate monthly-accrued volumes without any VMCS software integration.

Still yet another feature and advantage of the present invention is the ability of such a system and method to offer the opportunity for a merchant to accrue donated funds as derived from credit card transaction volume based upon capture and settlement of electronic transactions.

Yet still another feature and advantage of the present invention is the ability of such a system and method to provide a simple and easy to use turnkey solution that integrates a complete donation funding option at a point of sale device.

And still another feature and advantage of the present invention is the ability of such a system and method to generate funding accruals according to the merchant's monthly credit card transaction volumes as processed by the service provider.

Even still another feature and advantage of the present invention is the ability of such a system and method to secure the safety of accrued funds via escrow holding for deposit and exchange of processing fees.

Yet another feature and advantage of the present invention is the ability of such a system and method to facilitate automatic update of donated funds based on monthly accrual and disbursements of funds, wherein merchant business account funds are settled one month in arrears.

And yet another feature and advantage of the present invention is the ability of such a system and method to facilitate determination by the merchant of the amount of funds to be donated to his/her customer.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a general block diagram overview of a system and method of a point-of-sale, value added payment processing service according to a preferred embodiment of the present invention;

FIG. 2 is a general flow diagram of a system and method of a point-of-sale, value added payment processing service according to a preferred embodiment of the present invention;

FIG. 3 is a general flow diagram of operation of the system and method of FIG. 2, showing an exemplary veterinarian merchant;

FIG. 4 is a general flow diagram of operation of the system and method of FIG. 2, according to an alternate embodiment, showing incorporation of an insurance component;

FIG. 5 is an illustration of a printable document provided by the software application of the system and method of a point-of-sale, value added payment processing service, according to a preferred embodiment of the present invention; and

FIG. 6 is a mock merchant-user interface for the system and method of FIG. 1.

### DETAILED DESCRIPTION OF THE PREFERRED AND ALTERNATIVE EMBODIMENTS

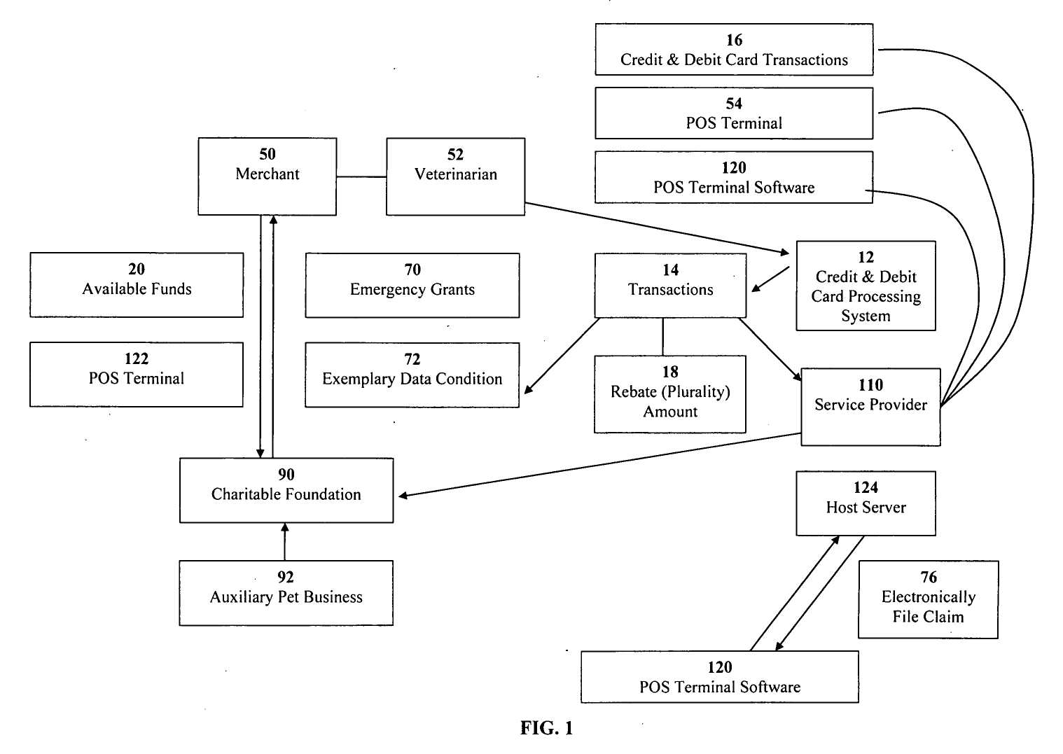

In describing the preferred and alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

As will be appreciated by one of skill in the art, the present invention may be embodied as a method, data transaction processing system, or computer program product. Accordingly, the present invention may take the form of an entirely hardware embodiment, entirely software embodiment or an embodiment combining software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present invention is described below with reference to flowchart illustrations of methods, apparatus (systems) and computer program products according to embodiments of the present invention. It will be understood that each block or step of the flowchart illustrations, and combinations of blocks or steps in the flowchart illustrations, can be implemented by computer program instructions. These computer program instructions may be loaded onto a general purpose computer, special purpose computer, point-of-sale terminal, or other programmable data processing apparatus to produce a machine, such that the instructions, which execute on the computer or other programmable data processing apparatus create means for implementing the functions specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions. Computer programming for implementing the present invention may be written in various programming languages, such as conventional C calling, database languages such as Oracle or .NET. However, it is understood that other source or object oriented programming languages, and other conventional programming language may be utilized without departing from the spirit and intent of the present invention.

Referring now to FIGS. 1-7, the present invention in its preferred embodiment is a method and system for providing point-of-sale, value added payment processing, with related reporting, management, and access via a global networking system, such as the Internet, wherein individual merchants can manage their escrow accruals, monitor their status relative to targeted consumer need, and thereby facilitate individual grant receipt via timely and organized analysis of accrued escrow funds, wherein payment processing services are provided via effective management, organization, verification and reporting of transactional activity, wherein merchant access to data and records is facilitated, and wherein selected and secure transfer of escrow and grant information and funds is enabled via confidential channels.

Thus, in general, the value added payment processing service and method of the present invention provides for centralized escrow of funds and specific information regarding the generation of such escrow funds, wherein merchant reliance upon such information is anticipated, and wherein such reliance necessitates verification and certification thereof. Such payment processing information may be of a sensitive nature, wherein security of access and content is critical. Moreover, such information also typically active, wherein ongoing periodic, preferably monthly, refreshment of charitable escrow data is necessary in order that grant review, certification and verifications may remain accurate and valid. Thus, the service and method of the present invention preferably defines a secure, custom, portable process capable of performing as a value-added, point of service charitable vehicle for any merchant accepting credit and/or debit card payments and utilizing the service provider for the present invention for processing of such transactions.

An exemplary computer system that could be utilized to provide a suitable environment for implementing embodiments of the present invention preferably includes computer architecture divided into two parts, the motherboard and the input/output (I/O) devices. The motherboard preferably includes subsystems such as a central processing unit (CPU), random access memory (RAM), input/output (I/O) controller, and read-only memory (ROM), also known as firmware, which are interconnected by bus. A basic input output system (BIOS) containing the basic routines that help to transfer information between elements within the subsystems of the computer is preferably stored in ROM, or operably disposed in RAM. The preferred computer system further includes I/O devices, such as a main storage device for storing an operating system and application program(s), and a display for visual output. Preferably, the main storage device is connected to the CPU through a main storage controller connected to bus. A network adapter preferably allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems may be connected in a similar manner, including but not limited to, devices such as microphone, speakers, sound card, keyboard, pointing device (e.g., a mouse), floppy disk, CD-ROM player, DVD player, printer and/or modem, each connected via an I/O adapter. Also, the devices and subsystems may be interconnected in many different configurations, or may be based on optical or biological processors or gate arrays, or some combination of these elements that is capable of responding to and executing instructions. The operation of such computer systems are readily known in the art and are not discussed in further detail in this application, so as not to overcomplicate the present discussion.

For further example, however, the preferred system and method of the present invention includes one or more user systems with one or more point of sale terminals, one or more server devices, and a global network, which could be, for example, the Internet. User systems each preferably include a computer-readable medium, such as random access memory, coupled to a payment processor. The processor executes program instructions stored in memory. User systems may also include a number of additional external or internal devices, such as, without limitation, a scanner, a mouse, a CD-ROM, a keyboard, a display, a storage device and other attributes. Such a system typically includes one or more user systems. For example, the preferred user system may include one or more general-purpose computers (e.g., personal computers), one or more special purpose computers, such as point of service terminals (e.g., devices specifically programmed to communicate with the server system and/or each other), a workstation, a server, a device, a digital assistant or a “smart” cellular telephone or pager, a component, other equipment, or some combination of these elements that is capable of responding to and executing instructions.

Similar to a user system, the preferred server system includes a computer-readable medium, such as random access memory, coupled to a processor. The processor executes program instructions stored in memory. The server system may also include a number of additional external or internal devices, such as, without limitation, a mouse, a CD-ROM, a keyboard, a display, a storage device and other attributes. The server system may additionally include a secondary storage element, such as a database for storage of data and information, and although capable as a single computer system, is preferably implemented as a network of computer processors. Memory in the server system preferably contains one or more application program(s). For example, the server system may include one or more general-purpose computers (e.g., personal computers), one or more special purpose computers (e.g., devices specifically programmed to communicate with each other), a workstation or other equipment, or some combination of these elements that is capable of responding to and executing instructions.

The system is preferably capable of delivering and exchanging data between the user system and the server system through communication links and/or a network. Preferably, through the user system, users can communicate over a network with other systems and devices coupled to the network, such as the server system. The communications link preferably includes a delivery network making a direct or indirect communication between the user system and the server system, irrespective of physical separation. Examples of a network include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link may preferably include, for example, a wired, wireless, cable, optical or satellite communication system or pathway.

An application program preferably facilitates merchant users of the system to process credit and debit transactions and to maintain related information via a transactional data repository operated from the server system, and enables a merchant user from user system to query and track the current, historical and target transactional materials. Preferably, the system enables users to communicate with the service provider via the user system and server system, and to request grant authorization therefrom.

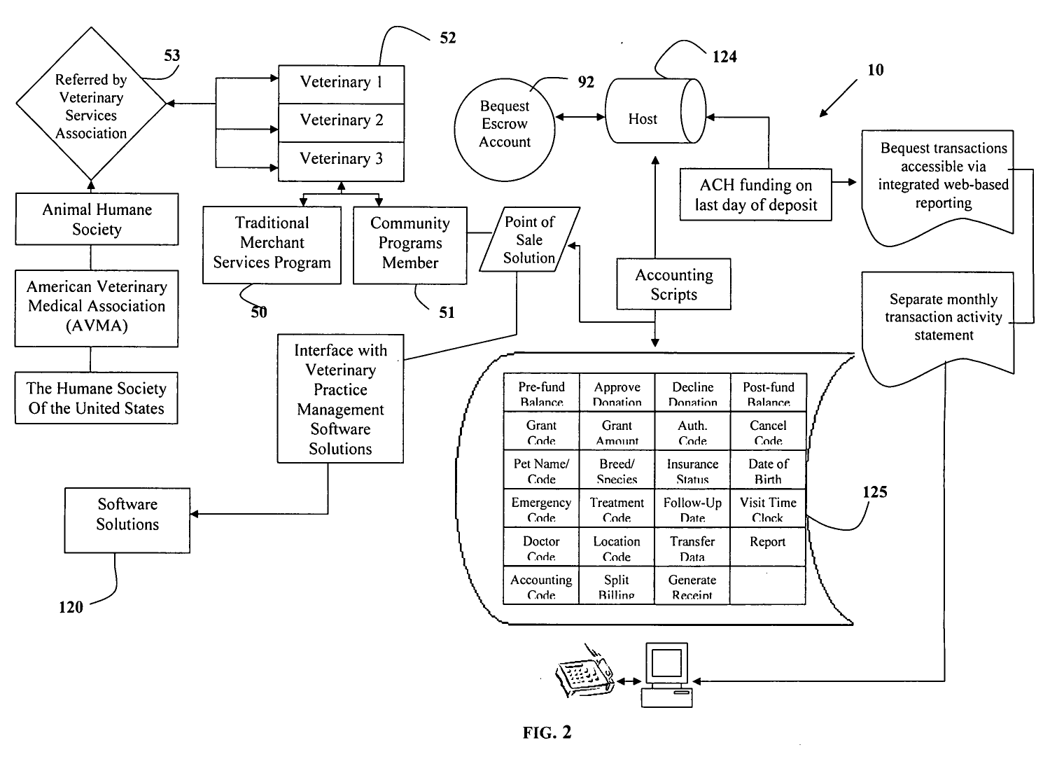

Referring now to FIGS. 1 and 2, the point-of-sale, value added payment processing system 10 and method thereof, of the present invention preferably enables a merchant 50 to request and receive emergency grants 70 from a charitable foundation 90 operated by the service provider 110. One exemplary merchant 50 receiving payment for services and goods via credit card transactions and to whom the present invention would be applicable is a veterinarian 52, wherein such exemplary use is carried throughout this specification as one specific and preferential application. Such exemplary use, however, is not intended to be limiting, wherein many other suitable merchants could benefit from the application of the present invention, including those offering only services, those offering only goods, and those offering both goods and services. It should be recognized that some adaptation of the generally preferred features of the present invention may be required in order to best facilitate the specific charitable needs and/or specific manner of consumer interactions for a given merchant 50, but such adaptation is intended under the scope of the present invention.

Thus, point-of-sale, value-added payment processing system 10, and method thereof, preferably enables a veterinarian 52 to request and receive an emergency grant 70 for pet care from a charitable foundation 90 operated by the service provider 110. It is preferred that foundation 90 be indirectly funded by a plurality of merchants 50 that utilize the credit and debit card processing system 12 offered by service provider 110, wherein those plurality of merchants 50 operate within the pet industry, and wherein the charitable funds are drawn from profits from related to transactions 14 executed via credit and debit card processing system 12. Although it is preferred that the funding of charitable foundation 90 is accomplished via merchants 50 utilizing credit and debit card processing system 12, other funding sources may also be utilized, such as for exemplary purposes only, community program membership donations 51, individual and/or corporate charitable donations, governmental financial aid, or membership, insignia, and/or certification mark product revenue, such as by endorsement and/or referral by veterinary services associations 53.

The preferred funding structure, wherein charitable foundation 90 is fully funded as a result of a business relationship between merchant 50 and service provider 110, is referred to herein as community funding donation application 14. In order to accomplish community funding donation application 14, service provider 110 preferably integrates credit and debit card processing system 12 with point-of-sale (POS) terminal software 120. Preferably, point-of-sale, value added payment processing system 10 integrates with a plurality of types of POS terminal software 120 in order to facilitate seamless installation and operation. Exemplary veterinary practice management software solutions are ALTAPOINT, AMBER, ANIMED, AVIMARK, AVS, BRIDGE, CBS, CIS VET, CLIENTTRAX, CORNERSTONE, DATAWARE, DOGDOC, DOTY, DVMANAGER FROM CANADA, EASY MINDER, EDMS, EQUISOFT, FOXPRO, PEAC IBS, IMPROMED, IMS, INTRAVET DOS, JADE, JP DODGEN, NEWSOFT VOS2 HTREE, PERFECTVET, PSI, QUICKBOOKS, QUICKREG, SELZLER, SILVERCLOUD, SOFTQUEST, SOFTVET, STAMPEDE, SUNPOINT, SYNERGY, ULTRAVET, VBOSS, VDBS, VET PAC, VET TECH, VETBASE, VETECH, VETKARE, VETLOGIC, VETSOFT, VISIONARIAN, VISUAL VETERINARY SOLUTIONS, VMS (Kapron Corp.), VIS-ALPHA MICRO, and VTECH WINDOWS; however, such examples are not intended to be exhaustive.

Following the preferred integration of credit and debit card processing system 12 by service provider 110 into POS terminal 54 of veterinarian 52, credit and debit card transactions 16 are processed and monitored by service provider 110. At the conclusion of a selected period, preferably one month, amount 18 is calculated according to the volume of credit and debit card transactions 16, and rather than provide a rebate to a referral channel according to known systems, amount 18 is allocated to charitable foundation 90.

Each veterinarian 52 that utilizes point-of-sale, value added payment processing system 10 as offered by service provide 110 can preferably access and inquire regarding available funds 20 accumulated via allocation of plurality of amounts 18 via a global networking system, such as the Internet. Additionally, it is preferred that a veterinarian 52 can apply for receipt of emergency grant 70 from available funds 20 to supplement the emergency care needs of an animal, with such application for grant 70 facilitated at POS terminal 122, via a global networking system, or via any other convenient and suitable means of communication.

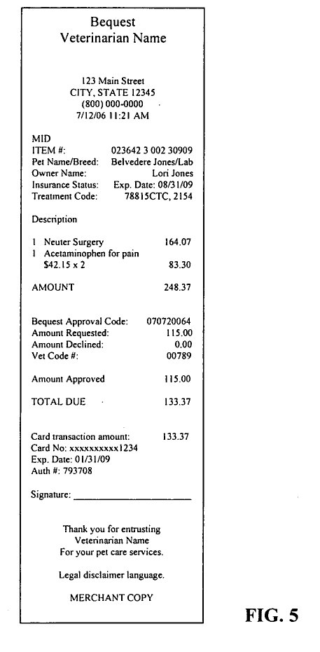

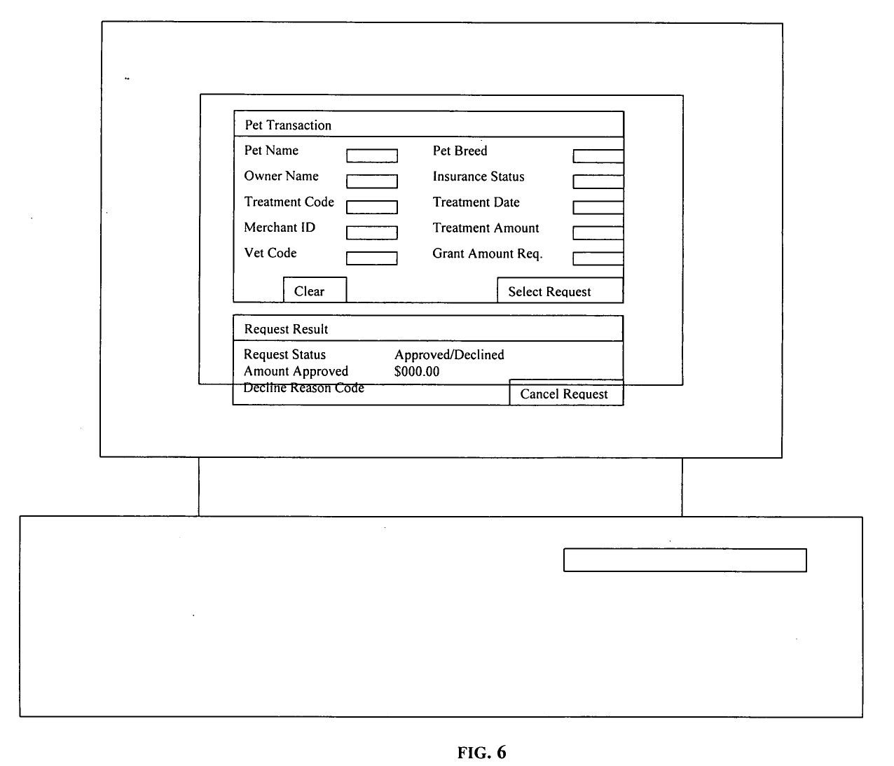

FIG. 5 depicts exemplary report 401 that may be available to members 50, and exemplary user interface 400 is shown in FIG. 6. User interface 400 is preferably a general user interface (GUI) computer screen such as website pages and the like having text, graphics, text entry windows, drop down selection windows, radial buttons, clickable buttons and the like. Website pages are readily known in the art and are not discussed in further detail in this application, so as not to overcomplicate the present discussion. Preferred screen shot report 401 preferably is a graphical user interface generated by host server 124 and communicated to merchant 50, wherein merchant 50 preferably clicks on a button of interface 400 sending a request to server 124, wherein server 124 preferably searches or queries data records in response to the request for information, and server 124 preferably communicates such information to merchant 50 via report 401. Interface 400 and report 401 are preferably generated using a common internet language such as HTML or XML. “Common internet language” as used herein means a computer programming language that is a standard or common programming language designed to facilitate communication between the different types of computers and operating systems found on the Internet, and specifically includes all versions of Java, HTML (hypertext markup language) and XML (extensible markup language) or any other webpage development language.

In general, WebPages are stored in Java, HTML or XML format in association with “server” software at server 124. A webpage, such as interface 400, is given a “Uniform Resource Locator” (URL) which is essentially an address path identifying the server which hosts the desired document plus the location of the document on the server. Using “browser” software, an end-user can send a request from merchant 50 to access a webpage stored at a particular URL. Browser software such as INTERNET EXPLORER or NETSCAPE is well known and widely available. When server 124 receives the request from merchant 50, it sends the requested HTML or XML webpage to merchant 50 where the document can be displayed. The communication protocol used in making such a request and in transferring WebPages is “Hypertext Transfer Protocol” (HTTP).

Interface 400 and report 401 preferably include but are not limited to header 410, category tabs 420, side bar 430, and body 440 which organize each page into regions having text, graphics, text entry windows, tabs, hyper links, drop-down selection windows, radial buttons, clickable buttons and the like. Any suitable format may be utilized for expression of the information.

Credit and debit card processing system 12, offered by service provider 110 and preferably integrated with POS terminal software 120, further communicates with host system 124 of service provider 110, wherein upon receipt of a request for emergency grant 70, host system 124 preferably runs a series of algorithms to determine availability of funds for immediate care assistance, and to capture all information necessary to determine approvable grant amounts. Thus, host system 124 decides the appropriate total grant according to plurality of data conditions 72 and responds to veterinarian 52 at POS terminal 122 essentially immediately. Plurality of activities 125 preferably performed, monitored, and/or reported by host system 124 are exemplarily shown in FIG. 2. Service provider 110 preferably transmits approved funds for each emergency grant 90 according to credit card deposit method 22 established for veterinarian 52.

Preferably, plurality of data conditions 72 are utilized by service provider 110 to determine limitations to award of a grant 70, wherein one such data condition 72 is credit card sales volume of veterinarian 52. Another exemplary data condition 72 is per capita income statistics 76 for regions related to veterinarian 52, such as zip code and county defined regions. Still another exemplary data condition 72 is actual allocation wishes or direction as received from a private contributor. Yet another exemplary data condition 72 is the status of donations from auxiliary pet businesses 92, discussed in more detail herein below, wherein auxiliary pet businesses 92 may be contributing members to charitable foundation 90 as part of system and method 10 of the present invention.

Another preferred feature for point-of-sale, value added payment processing system and method 10 relates to insurance. Accordingly, it is preferred that veterinarian 52 can validate the existence of insurance coverage for a pet, determine whether the recommended procedure or treatment is covered, and ascertain the expected amount of coverage, or payable benefit. This feature is intended to assist veterinarian 52 and the pet owner in accurately determining the potential out of pocket expenses, wherein veterinarian 52 can request grant 70 from charitable foundation 90 in an amount tailored to cover the shortfall of the insurance benefit.

Preferably, host system 124 of service provider 110 communicates with the host of the insurer 126, utilizing a series of predetermined insurance factors to determine and transmit an authorized amount to the integrated POS solution. Further, it is preferred that host system 124 of service provider 110 electronically file claim 76 with insurer 126, wherein receipt of insurance reimbursement funds is preferably direct and electronic, thereby reducing the need for paper insurance submissions and streamlining the process.

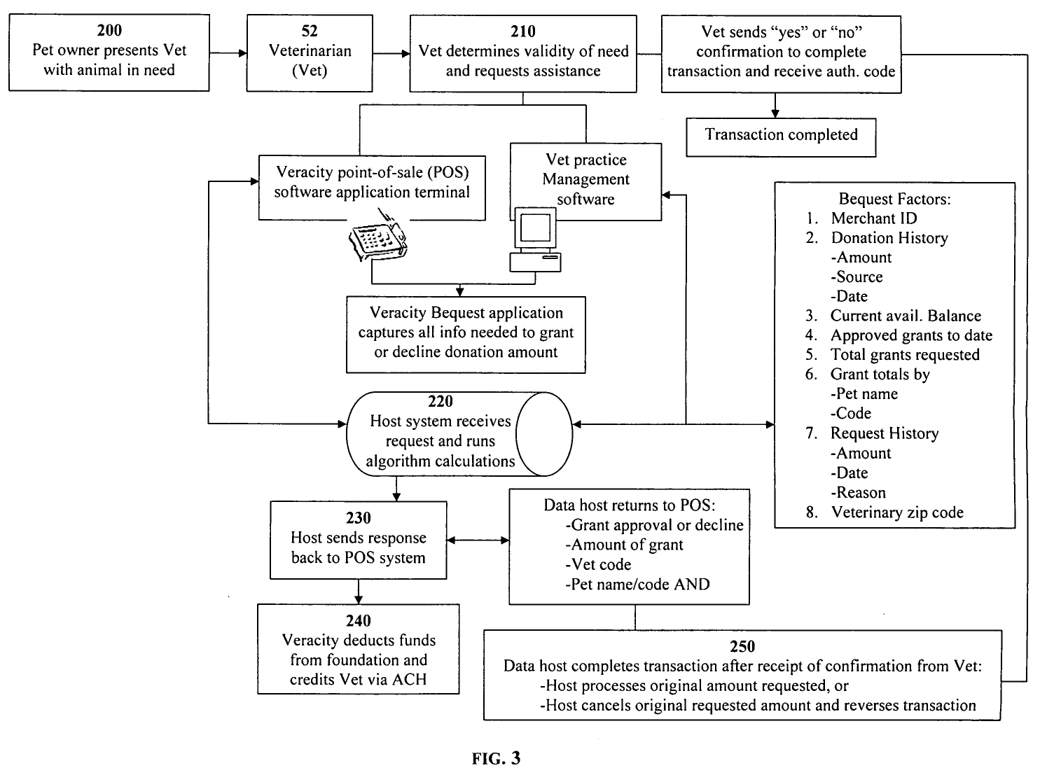

Referring now to FIG. 3, a flow diagram of an operational exemplar of use of system and method 10 by a veterinarian is shown. In step 200, a pet owner presents merchant member veterinarian 52 with an animal in need of treatment. Veterinarian 52 determines the needs of the animal and renders the decision to seek financial assistance from charitable organization 90 in step 210. Preferably, POS software application terminal 54 is integrated with veterinarian practice management software 120, wherein veterinarian 52 may communicate the request for grant 70 to charitable organization 90 via service provider 110 as a result of such integration, wherein application for grant 70 captures all information needed to evaluate the grant request.

In step 220, host server 124 receives the grant request and runs algorithm calculations. The algorithm calculation preferably address factors such as, and without limitation, (1) merchant identification, (2) donation history such as amount, source, and date, (3) current available balance, (4) approved grants to date, (5) total grants requested, (6) grant totals by pet name and code, (7) request history such as amount, date, and reason, and (8) veterinarian zip code. The responsive decision according to the algorithm calculations is preferably sent back to the POS software application terminal 54, wherein data reported preferably comprises a response regarding grant approval or decline, the amount of the grant, the vet code, and the pet name and code. Essentially coincidently therewith, at step 240, service provider 110 deducts appropriate funds from charitable foundation 90 and credits veterinarian, preferably via Automated Clear House (ACH) nationwide electronic funds transfer network.

Following notification of grant approval, according to step 250, veterinarian 52 completes and finalizes the transaction by confirming, wherein either the host server 124 concludes processing of the original grant amount requested, or host server 124 cancels the original grant amount and reverses the transaction.

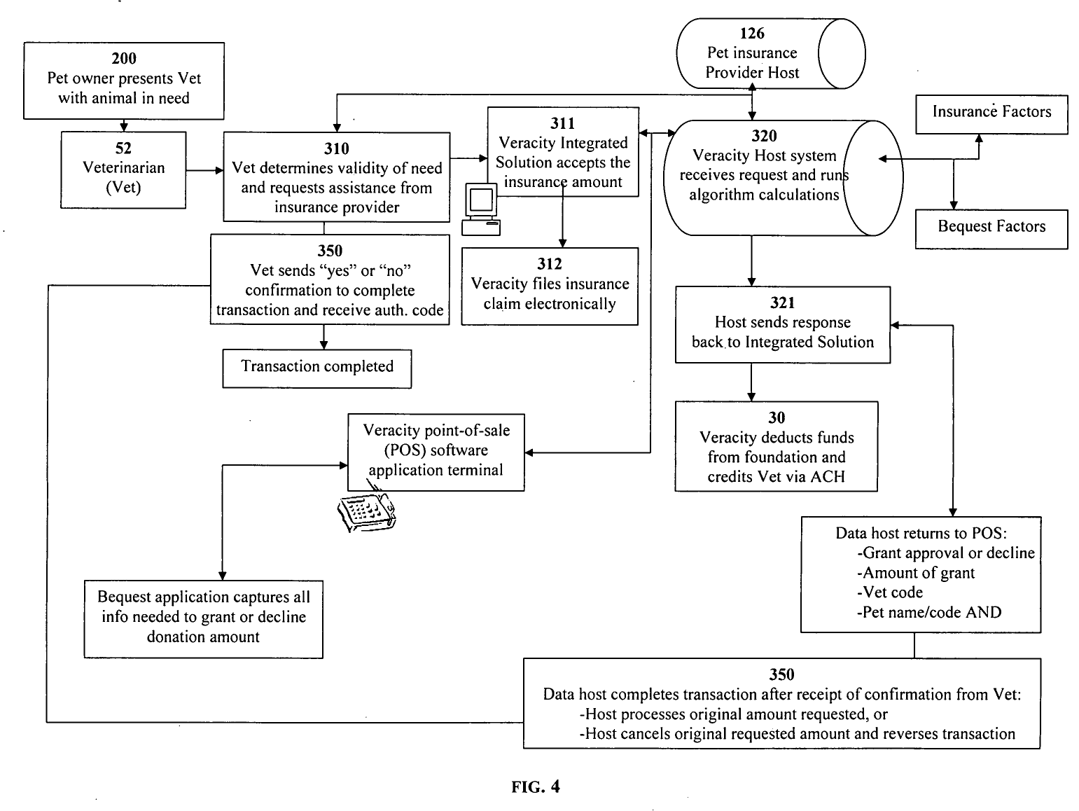

Similarly, and with reference now to FIG. 4, a flow diagram of an operational exemplar of use of system and method 10 by a veterinarian is shown, wherein incorporation of a pet insurance component is further accomplished. Again, in step 200, a pet owner presents merchant member veterinarian 52 with an animal in need of treatment. Veterinarian 52 determines the needs of the animal and renders the decision to seek assistance via claim to insurance provider 126 in step 310. Service provider 110 preferably receives data from insurance provider 126, noting the approved and/or declined insurance coverage amount 311, and preferably proceeds with filing of the claim in step 312, preferably via electronic means; however, other suitable means could also be utilized.

In step 320, host server 124 receives the grant request and runs algorithm calculations, as previously discussed, yet preferably also with additional insurance factors such as, and without limitation, (1) insured policy number, (2) insurance history, (3) current available balance, (4) approved insurance amounts to date, (5) total amount requested, (6) amount request totals by policy number, (7) insured eligibility, (8) amount paid totals by policy number, (9) request code, and (10) prognosis. The responsive decision according to the algorithm calculations is preferably sent back to the POS software application terminal 54 at step 321, wherein data reported preferably comprises a response regarding grant approval or decline, the amount of the grant, the vet code, and the pet name and code. Essentially coincidently therewith, at step 340, service provider 110 deducts appropriate funds from charitable foundation 90 and credits veterinarian via ACH.

Following notification of grant approval, according to step 350, veterinarian 52 completes and finalizes the transaction by confirming, wherein either the host server 124 concludes processing of the original grant amount requested, or host server 124 cancels the original grant amount and reverses the transaction.

It should be recognized that the method of providing point-of-sale value added payment processing system 10 according to the present invention is preferably embodied in software 120. As noted above, one commodity of software 120 is data, wherein merchant portfolios are grown in acquisition mode. In the exemplary preferred embodiment related to veterinary services, exceptional payment processing and information gathering services are provided via this point-of-sale solution with web-based reporting and management.

Preferred product flow thus revolves from host provider 124, who manages escrow account 92 for fund donations, who processes accounting scripts from unique software solution 120, either integrated within point-of-service terminal 54 or via a web-based point-of-service portal. Software 12 preferably includes such general service action headings of pre-fund balance, approve donation, decline donation, post-fund balance, grant code, grant amount, authorization code, cancel code, pet name/code, breed/species, insurance status, date of birth, emergency code, treatment code, follow-up date, visit time clock, doctor code, location code, transfer data, report, accounting code, split billing, and generate receipt. Each is preferably available at the interface with the veterinary practice management software solution 120. Separate monthly transaction activity statements are also provided, with transactions preferably accessible via integrated web-based reporting, with ACH funding on last day of deposit.

It should be recognized that although the preferred program flow of software 120 has been discussed, any suitable program flow could be utilized to effectuate software application 120 without departing from the appreciative scope of the present invention, as such alternate program flows are in full contemplation of the inventor in describing the present invention herein. As such, any process descriptions or blocks in the program flow should be understood as representing modules, segments, or portions of code which include one or more executable instructions for implementing specific logical functions or steps in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

In an alternate embodiment, member merchants 50 and/or other community program members 51 that accept credit cards are provided with genuine value added services and products. For example, a plurality of products could be offered by other community program members 51, such as pet related merchants 92, wherein such products could bear a certification and/or membership mark related to participation and/or certification of point-of-sale, value added payment processing system 10 and/or relationship with charitable organization 90. It is envisioned that a contribution to charitable organization 90 could be realized according to purchase of such plurality of items so marked, when the purchase transaction is processed by service provider 110. That is, a product logo could be put on related pet goods for sale, and/or a consumer loyalty card could also be issued, wherein purchase of a good would result in issuance of a coupon to the consumer, for example, and/or wherein processor 110 could issue vertical reward for use of the card.

In another alternate embodiment, pet insurer 126 could have automatic data transfer with veterinarian 52 via system and method 10. Further, another alternate benefit for veterinarian 52 could be revenue generation via franchisee relationship to pet insurer 126.

In yet another alternate embodiment, although system and method 10 is preferably a stand-alone software application that integrates with point-of-sale credit card terminals, it is intended that system and method 10 be capable and adapted as a full end-to-end solution as a merchant processing donation product.

Finally, transactions according to system and method 10 may flow according to one or more of the following specific procedures, wherein one skilled in the art will readily recognize that the foregoing description regarding the general scope of the present system and method 10 are not intended to be limited thereby, but where the specific procedures are intended to be exemplary, but not exclusionary, protocols that may be selectively followed. For example, a request for authorization may be begin when, (1) veterinarian 52 enters an estimated procedure amount, the amount of requested emergency grant 70, the pet owner's contact/identification data, such as telephone number, and, optionally, an invoice number, into terminal 54, whereafter, (2) terminal software 120 checks the request amount against a local “maximum” grant value, wherein such maximum grant value is preset by arrangement, and wherein such local value may be, for example, initially defined at $100.00. The local value threshold is an artificial construct to facilitate ease and immediacy of grant for a lesser award without preliminary processing steps, wherein with a defined time period, veterinarian 52 is permitted a defined local maximum grant total.

The next step in an authorization proceed when, (3) terminal 54 contacts host 124 and transmits the approval request message, wherein the transmitted message data may include, for example, and without limitation, TID, MID, batch number, transaction number, procedure amount, request amount, invoice number and pet owner contact/identification information, such as telephone number. Host 124 processes the request by, (1) performing processing and calculating an amount for emergency grant 70, (2) writing a transaction history record, and (3) formatting a response message.

Calculation of the amount for emergency grant 70 may begin with a check of rules, preferably according to a “rules set to use” field on the Master file, wherein a first rule set may be defined to consider if the funds currently available total is less than $100.00, then approval is granted for a $10.00 grant, and otherwise, approval is granted for an amount equal to the average grant amount for the immediately preceding 30 days. It should be understood that other rule sets may be utilized in addition or in lieu of the foregoing exemplary first rule set. Following the determination regarding the allowed amount for grant 70, host 124 sends a responsive message back to terminal 54, wherein the message data may include, for example, the amount approved, an approved/declined status indicator, an approval code, a decline reason code, date, time, a confirmation indicator, and a sponsor name. Thereafter, terminal 54 adds the transaction into its local batch of credit and debit card transactions 16, and may print a receipt showing the estimated procedure amount, the grant amount approved, a transaction number, sponsor name, or the like, as is representarily depicted in FIG. 5.

As noted hereinabove, to finalize and complete the transfer of funds for grant 70, veterinarian 52 is preferably required to confirm acceptance of the transaction to host 124. The procedure for acceptance may be accomplished according to a batch edit mode for terminal 54, wherein (1) terminal 54 prompts for a transaction number; (2) vet 52 enters the transaction number; (3) terminal 54 displays the amount of grant 70 related to the transaction number entered and queries regarding acceptance; (4) vet 52 indicates affirmatively or negatively, wherein if vet 52 indicates affirmatively, terminal 54 updates the confirmation indicator to a confirmed status for the transaction record, and finally wherein the batch edit mode is exited by vet 52 upon entry of exit/cancel command.

In order to transfer all transactional data from terminal 54 to host 124, a batch upload may be performed, such as at the end of each day, wherein merchant 50 may initiate the batch upload from terminal 54 to host 124. Each batch may exemplarily comprise a header record, a record for each transaction 16 in the batch, and a trailer record, wherein transaction data may exemplarily include merchant identification (MID), terminal identification (TID), batch number, transaction number, amount requested, amount approved, date, time, approved/declined indicator, approval code, decline reason code, owner phone number, confirmation indicator, and sponsor name.

Further, file transfers according to system and method 10 may proceed according to one or more of the following specific procedures, wherein one skilled in the art will readily recognize that the foregoing description regarding the general scope of the present system and method 10 is not intended to be limited thereby, but where the specific procedures are intended to be exemplary, but not exclusionary, protocols that may be selectively followed. Accordingly, file transfers from service provider 110 to host 124 may include a merchant master file and a funds master file, wherein at a specified interval, such as nightly, service provider 110 will build these files and populate data elements per the file descriptions, and with the secure file transfer protocol (SFTP), the files to host 124. File transfers from host 124 to service provider 110 may include a funds master file, an authorization log file, and a settlement file, wherein at a plurality of intervals through each day, the funds master file and the authorization log file may be updated by host 124, and wherein at a specified interval, such as at the end of each business day, the settlement file is built by host 124, with SFTP of all of the files to service provider 110 at a specified interval, such as each night.

Again, although the description given above includes specific examples of currently envisioned protocols and embodiments of the computer program, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A payment processing system, comprising:
a central server system;
a data processing and storage device connected to said central server system and that utilizes a computer program to host, accrue, calculate, disburse and report monthly donations earned by a participating merchant, said donations based upon credit card processing transaction volume, and said donations selectably applicable by said participating merchant for credit to a selected customer transaction.

2. A method of providing point-of-sale, value added payment processing, comprising the steps of:
accruing data from payment processing transactions of a merchant;
rendering managed, accrued data accessible to said merchant via a global networking system;
operating and managing a charitable organization at least partially funded by at least a portion of said revenue from said payment processing transactions of said merchant;
providing a system of grant allowance to said merchant, wherein said grant allowance is determined according to said funds of said charitable organization received from said payment processing transactions of said merchant, and wherein said grant allowance is predicated upon application to a subsequent payment processing transaction of said merchant.

3. The method of claim 2, wherein said method is embodied in a software product, and wherein said software product is adapted for use with a known merchant software management solution.

4. The method of claim 2, wherein said method is embodied in a full featured point-of-sale terminal device.

5. The system of claim 1, wherein said participating merchant is a veterinary service provider.

6. The method of claim 2, wherein said merchant is a veterinary service provider and wherein each said allowed grant funds at least a portion of a veterinary service.

7. The method of claim 6, wherein said system of grant allowance further comprises the steps of:
accessing of said accrued data via said global networking system by said veterinary service provider, wherein said accrued data further comprises available grant funds from said charitable organization;
identifying a consumer with a pet in need of veterinary services with a cost;
authorizing by said veterinary service provider for at least a portion of said available grant funds to be disbursed for application to said cost of said veterinary services of said identified consumer; and
receiving said at least a portion of said available grant funds by immediate disbursement from said charitable organization.

8. The system of claim 1, wherein said donations are held in escrow, and wherein said escrow donations are accessible to said participating merchant for discretionary and essentially immediate funding of said selected customer transaction.

9. The system of claim 1, wherein said computer program also acquires information while processing each said credit card processing transaction.

10. The method of claim 2, wherein said data accrued from said payment processing transactions further comprises information regarding a party to said transaction.

11. The system of claim 1, wherein said credit card processing transaction volume is based on capture and settlement of electronic transactions.

12. The method of claim 3, further comprising certification of participating providers and vendors.

13. The method of claim 2, wherein a merchant business account fund for said merchant is settled one month in arrears according to said data accrued from said payment processing transactions.

14. The system of claim 1, wherein said basis of said credit card processing transaction volume defining said donations is determined by said participating merchant.

15. The method of claim 2, wherein said portion of said revenue from said payment processing transactions that funds said charitable organization is selected by said merchant.

16. The method of claim 2, further comprising the steps of:
accessing, by said merchant, said managed, accrued data;
managing, by said merchant, of an escrow accrual;
monitoring, by said merchant, of a grant fund status; and
facilitating, by said merchant, of an individual grant disbursement and receipt said accrued escrow funds.

17. The system of claim 1, wherein said merchant is any merchant offering goods or services and accepting credit or debit card payments.

18. The method of claim 6, wherein said charitable organization is funded by a plurality of merchants, wherein each of said merchants of said plurality operates within the pet industry.

19. The method of claim 2, wherein said charitable organization receives funding from at least one further funding source, wherein said at least one further funding source is selected from the group consisting of community program membership donations, individual charitable donations, corporate charitable donations, governmental financial aid, membership revenue, insignia revenue, certification mark product revenue, endorsement revenue, and veterinary services association referral.

20. The method of claim 3, wherein said known merchant software management solution is selected from the group consisting of ALTAPOINT, AMBER, ANIMED, AVIMARK, AVS, BRIDGE, CBS, CIS VET, CLIENTTRAX, CORNERSTONE, DATAWARE, DOGDOC, DOTY, DVMANAGER FROM CANADA, EASY MINDER, EDMS, EQUISOFT, FOXPRO, PEAC IBS, IMPROMED, IMS, INTRAVET DOS, JADE, JP DODGEN, NEWSOFT VOS2 HTREE, PERFECTVET, PSI, QUICKBOOKS, QUICKREG, SELZLER, SILVERCLOUD, SOFTQUEST, SOFTVET, STAMPEDE, SUNPOINT, SYNERGY, ULTRAVET, VBOSS, VDBS, VET PAC, VET TECH, VETBASE, VETECH, VETKARE, VETLOGIC, VETSOFT, VISIONARIAN, VISUAL VETERINARY SOLUTIONS, VMS (Kapron Corp.), VIS-ALPHA MICRO, and VTECH WINDOWS.

21. The system of claim 2, wherein said system of grant allowance further comprises the steps of:
applying for a grant by said merchant via said global networking system;
running a series of algorithms by a host to determine availability of said funds; and
responding by said host to said merchant, wherein at least one of a plurality of activities is performed, monitored or reported by said host, and wherein said at least one of a plurality of activities is selected from the group consisting of pre-fund balance, grant code, pet name/code, emergency code, doctor code, accounting code, approve donation, grant amount, breed/species, treatment code, location code, split billing, decline donation, authorization code, insurance status, follow-up date, transfer data, generate receipt, post-fund balance, cancel code, date of birth, visit time clock, and report.

22. The system of claim 2, wherein said system of grant allowance further comprises a plurality of data conditions to determine limitations to award of a grant, and wherein said plurality of data conditions is selected from the group consisting of credit card sales volume of said merchant, per capita income statistics for zip code regions related to said merchant, per capita income statistics for county defined regions related to said merchant, actual allocation wishes as received from a private contributor, and status of donations from auxiliary businesses

23. The system of claim 1, wherein data processing and storage device utilizes said computer program to enable said merchant validate the existence of insurance coverage, to determine whether a recommended procedure or treatment is covered, and to ascertain an expected amount of payable benefit.

24. The system of claim 23, wherein an insurance claim is electronically filed by said computer program.

25. The system of claim 21, wherein said series of algorithms address one or more factors selected from the group consisting of merchant identification, donation amount history, donation source history, donation date history, current available balance, approved grants to date, total grants requested, grant totals by pet name and code, amount request history, date request history, reason request history, veterinarian zip code, insured policy number, insurance history, approved insurance amounts to date, amount request totals by policy number, insured eligibility, amount paid totals by policy number, request code, and prognosis.

26. The method of claim 19, wherein said certification revenue is derived from a plurality of products offered by a plurality of community program members, wherein said plurality of products could bear a certification mark verifying a relationship with said charitable organization.

27. The method of claim 26, further comprising a consumer loyalty card, generating a reward for purchase of a certified good.
